(19) United States
(12) Patent Application Publication
(10) Pub. No.: US 2014/0087336 A1
(43) Pub. Date: Mar. 27, 2014

(54) PHYSIOLOGY AND EXERCISE MANAGEMENT SYSTEM BASED ON BODY WEIGHT DIFFERENCE AND HEARTBEAT RATE

(71) Applicant: Leao Wang, Taichung (TW)

(72) Inventor: Leao Wang, Taichung (TW)

(21) Appl. No.: 13/629,574

(22) Filed: Sep. 27, 2012

(51) Int. Cl. G09B 19/00

(52) U.S. Cl. 434/127

(57) ABSTRACT

A physiology and exercise management system based on body weight difference and heartbeat rate uses a common portable electronic device in line with a built-in APP imputation software program to impute a user's basal metabolic rate (BMR) and ideal calorie intake according to a difference value between the user's current body weight and an international standard body mass index (BMI) and then uses a heartbeat rate range to detect the user's calorie consumption situation and a concise balance chart to learn the relation between the user's calorie intake and total calorie consumption values, and increase or decrease of personal body weight, so that a specific user can manage and maintain the best physiological condition for a long term effectively according to the body type and exercise purpose.

### BACKGROUND OF THE INVENTION

1. Fields of the Invention

The present invention relates to a physiology and exercise management system based on body weight difference and heartbeat rate, and more particularly to the physiology and exercise management system using a portable electronic device with a built-in APP imputation software program and related accessory equipments, and its simple operation interface and concise balance chart to allow users to learn the relation of their calorie intake and total calorie consumption, so that a specific user can manage and maintain the best physiological condition according to the user's body type and exercise purpose for a long term effectively.

2. Description of the Related Art

As people nowadays already profoundly know the relation and importance of diets, exercises and physiological changes (including body weight, heartbeat, blood pressure, and body fat, etc), the temptation of delicious food and personal laziness have substantial effects on their failure of controlling their diets. Of course, they will not remind themselves for maintaining good exercise habits, and thus resulting in declined physiological conditions from the ideal health conditions, or even finding themselves in a sick condition that requires medical assistance. Until then, people are alerted of the necessity of controlling their diets and maintaining good exercise habits.

However, when we want to control our diet and establish the habit of managing our body weight, we find that there is no related accessory equipment or instrument to assist, remind or record our physiological change and calorie consumption, so that we know the change of our physiological change (particularly an increase of body weight) after an improper food intake takes place, and then we start doing exercises depending on the physiological changes (particularly doing all kinds of exercises blindly to attempt recovering the ideal physiological conditions).

As to most people, the effect of controlling diets and doing exercises voluntarily is usually not too good, and even brings frustrations that discourage people to keep going. After all, the way of controlling diets and doing exercises compulsorily without plans fails to increase our confidence and determination of carrying out the diet control and the exercise plan. At the beginning when the effect is low, people have doubts about the necessity of continuing their exercise and careful selection of food, and may give up and stop controlling their diets or doing exercises anymore, which may jeopardize their health.

### SUMMARY OF THE INVENTION

Therefore, a primary object of the present invention is to use a common portable electronic device (such as a personal mobile device such as a Smartphone, a PDA, a notebook computer, a tablet PC, and an e-Book) in line with a built-in APP imputation software program for imputing the user's basal metabolic rate and ideal calorie intake according to a difference value between the user's current body weight and an international standard body mass index, detecting the actual calorie consumption according to a heartbeat rate range, and operating with a concise balance chart to learn about the actual values of the calorie intake and the total calorie consumption, as well as their relation with an increase or decrease of the user's body weight.

Another object of the present invention is to provide a recommended physical activity (which is the recommended calorie-burn value), not only balancing the user's calorie intake only, but also definitely carrying out the recommended physical activity in compliance with the user's need.

A further object of the present invention is to let users know about their physical conditions anytime, so that the portable electronic device operated with the heartbeat detector can detect the user's heartbeat recovery rate.

According to the invention, the system comprises a portable electronic device with a built-in APP imputation software program, a body weight scale and a heartbeat detector, wherein the APP imputation software program has an imputation basis based on a basic parameter conversion table including an international standard body mass index value, a basal metabolic rate and a standard exercise heartbeat rate. As a result, when a user executes the APP imputation software program by a portable electronic device, the user inputs the user's personal basal physiological parameter through an operation interface first and obtains the most updated actual body weight value through an automatic transmission from the body weight scale. In addition, the user can obtain a body weight difference value between the user's current body weight and an international standard body mass index, and further imputes the user's basal metabolic rate and ideal calorie intake to be displayed on an operation interface of the portable electronic device through a concise balance chart. Moreover, the heartbeat detector timely and automatically transmits the user's current heartbeat rate and performs a conversion process and detects an oxygen exercise uptake, so as to learn the user's calorie consumption situation and display the situation in the concise balance chart synchronously, while the APP imputation software program records and updates the specific user's previous use result.

### BRIEF DESCRIPTION OF THE DRAWINGS

The accomplishment of this and other objects of the invention will become apparent from the following description and its accompanying drawings of which:

FIG. 1 is a flow chart of operating and controlling the present invention;

FIG. 2 is a schematic view of a concise balance chart of the present invention;

FIG. 3 is a schematic view of a dynamic simulated display of a concise balance chart of the present invention (used to indicate a calorie intake display block, a calorie burn display block and a balance pointer).

FIG. 4 is a schematic view of a dynamic simulated display of a concise balance chart of the present invention (used to indicate the display situation of a warning color block);

FIG. 5 is a schematic view of a dynamic simulated display of a concise balance chart of the present invention (used to indicate the display situation of an exercise color block);

FIG. 6 is a schematic view of a dynamic simulated display of a concise balance chart of the present invention (used to indicate the display situation of a target pointer); and

FIG. 7 is an execution performance chart of the present invention.

### DETAILED DESCRIPTION OF THE PREFERRED EMBODIMENT

The technical measures and characteristics of the present invention will become apparent with the detailed description of preferred embodiments accompanied with related drawings as follows:

Before the technical characteristics of the present invention are described, the following terminologies are defined first.

The international standard body mass index (BMI) refers to BMI=weight (kg)/height (m²) which serves as a standard for determining a fat or thin person, and the BMI value generally falls within a range of 22˜24 which is considered as an ideal body weight.

The basal metabolic rate (BMR) refers to the minimum amount of energy required for maintaining life when a human body is situated at an inactive condition. In addition, the basal metabolic rate increases with age, decreases with body weight, and increases with the increase of muscles.

The heart rate range is listed in the following table (adapted from the American College of Sports and Medicine, ACSM):

Maximum heartbeat rate per minute of each person=220-age

Heartbeat Objective of Exercise

50˜60%×Maximum heartbeat rate Maintaining health

60˜70%×Maximum heartbeat rate Controlling body weight

70˜80%×Maximum heartbeat rate Aerobic training

80˜100%×Maximum heartbeat rate Match training

In short, when our heartbeat is maintained at “50˜60%×Maximum heartbeat rate”, which is equivalent to our general lifestyle, and the calorie consumption of our body is equivalent to the basal metabolic rate. When our heartbeat is maintained above “60%×Maximum heartbeat rate”, the exercise condition is reached, and the calorie consumption of our body is equal to the sum of exercise consumption and the basal metabolic rate. In other words, the faster the heartbeat, the greater is the calorie consumption. Therefore, if the heartbeat value is maintained at the exercise condition continuously, the inventor of the present invention specifically categorizes it as the “effective heartbeat range”.

The heartbeat recovery rate refers to the heart's ability to return the heartbeat value from a higher value to a normal value per unit time after physical activity. In general, the faster the heartbeat value returning to its normal value, the better is our physical function.

Based on the aforementioned basic theories, the technical measures and characteristics of the present invention will become apparent through the detailed description of preferred embodiment and the illustration of a flow chart as follows.

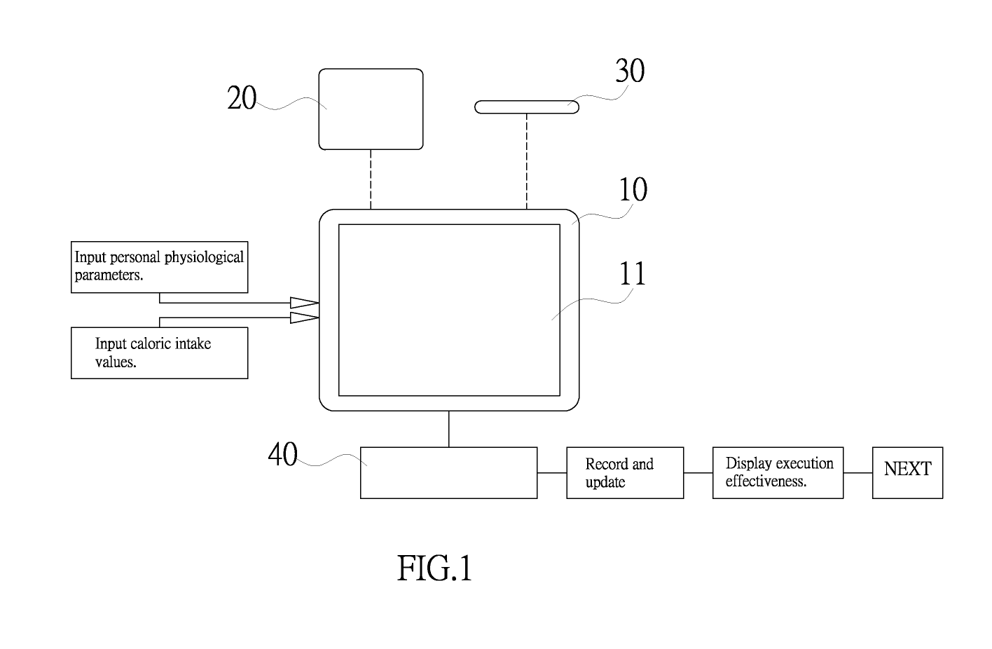

With reference to FIG. 1 for a flow chart of operating and controlling the present invention, the present invention comprises a portable electronic device 10 with a built-in APP imputation software program, a body weight scale 20 and a heartbeat detector, wherein the APP imputation software program has an imputation basis such as a basic parameter conversion table including the international standard body mass index, the basal metabolic rate and the standard heartbeat rate range, such that when a user executes the APP imputation software program by the portable electronic device 10, the user can enter the user's basic physiological parameters (including age, sex and each calorie intake value of a particular day) through an operating interface 11), and a body weight scale 20 is provided for automatically transmitting the actual updated body weight value of the user, and then the user can know about a body weight difference value between the current body weight and the international standard body mass index, and then the user's basal metabolic rate and ideal calorie intake can be imputed, and a concise balance chart 40 is provided and displayed on the operation interface 11 of the portable electronic device 10. Further, the heartbeat detector 30 also transmits the user's current heartbeat rate immediately and converts the heartbeat rate and detects an oxygen exercise uptake, so as to obtain and display the user's calorie consumption situation on the concise balance chart 40. Meanwhile, the APP imputation software program also records and updates the specific user's previous use results, so that a specific user can manage and maintain the best physiological condition according to one's body type and exercise purpose (such as the body weight control, the aerobic training or the match training).

The purpose of obtaining the body weight difference value is to actually reflect the user's body type such as a slight fat or slight thin body type or a skinny or overweight body type, so that related numeric values fitting a specific user best can be imputed according to the user's body build and requirements.

When the portable electronic device 10 executes the APP imputation software program, a function menu column (not shown in the figure) is displayed on the operation interface 11 and provided for the users to select one of the management purposes such as a health management, a weight loss management, an aerobic training management and a match training management.

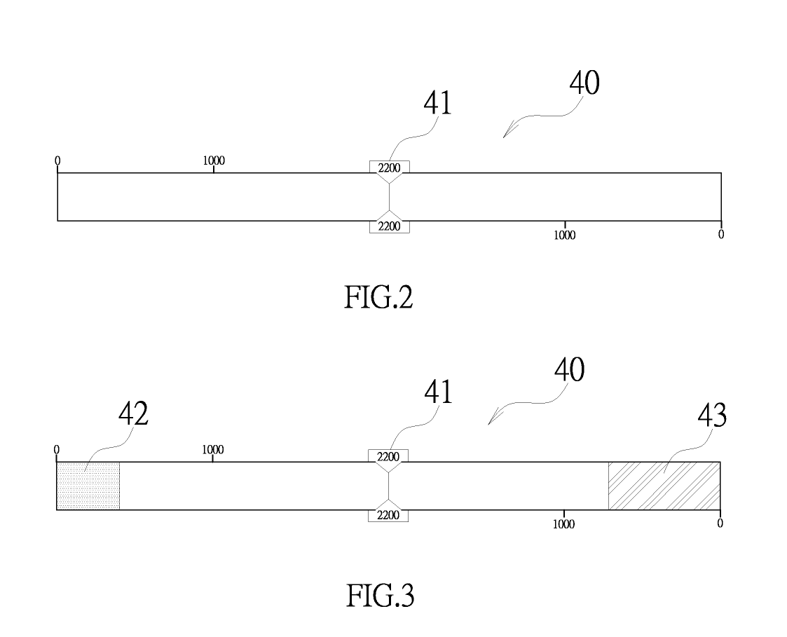

With reference to a concise balance chart 40 as shown in FIGS. 2 and 3, a simulation of an actual using situation is used for illustrating the operation of the present invention as follows.

When the portable electronic device 10 executes the APP imputation software program, a user enters basal parameter data including age (which is inputted for the first time of use only), sex (which is inputted for the first time of use only) and each calorie intake value of the day from the operation interface 11, and then enters the current body weight value through a body weight scale 20 automatically, so that the APP imputation software program can display the ideal calorie intake and basal metabolic rate of the user on the concise balance chart 40 according to the aforementioned imputation flow. Assumed that the imputed basal metabolic rate and ideal calorie intake are 2200 calories, a balance pointer 41 at the middle of the concise balance chart 40 serves as a boundary, and shows the imputed calorie value, wherein the left side of the balance pointer 41 is an actual calorie intake display block 42 (entered by the user and accumulated), and the right side of the balance pointer 41 is a calorie burn display block 43.

Wherein, the calorie intake display block 42 is represented by a warning color (such as red), and the calorie burn display block 43 is represented by a contrast color (such as green), and the two can be read and determined clearly (as shown in FIG. 3).

After the user enters the caloric values of the food intake of the three meals or anytime, the calorie intake display block 42 is extended gradually towards the balance pointer 41 by the accumulation, so that the user can immediately know that the total food intake has approached, reached or exceed the ideal calorie intake, and may start controlling the diet immediately.

Similarly, when the user is not doing any exercise to let the heartbeat be maintained at the effective heartbeat range, the calorie burn display block 43 is still extended gradually towards the balance pointer 41 due to the basal metabolic rate. If the user's accumulated food intake is controlled to 2200 calories, then the user can impute the concise balance chart 40 again after all activities of a day (wherein 24 hours are used as a cycle for statistics, and if the zero hour of a day is used as a start, then another imputation is required at the zero hour of the other day, and the execution process of the previous day is recorded) end. The basal metabolic rate is also equal to 2200 calories, so that the so-called balance situation can be achieved. In other words, both of the calorie intake display block 42 and the calorie burn display block 43 reach the balance pointer 41. Theoretically, the user does not have extra fact at this time anymore, and the user's body weight will not be increased.

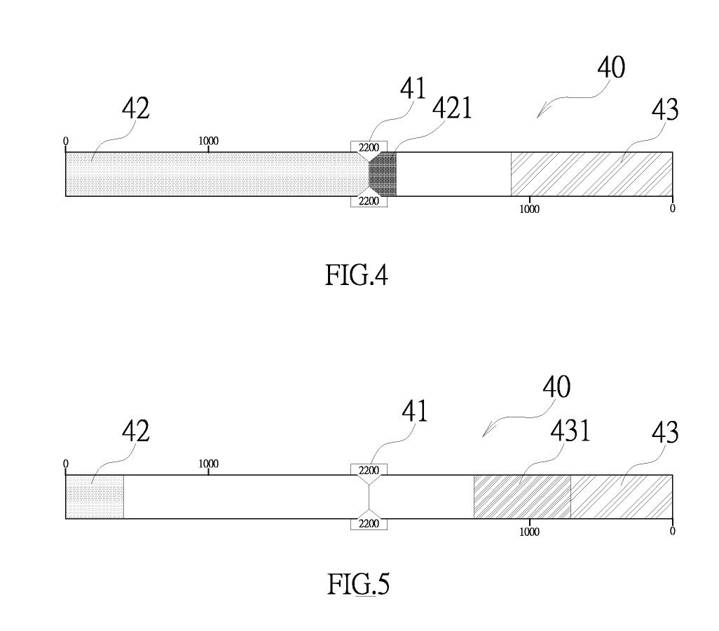

If the user's food intake exceeds the imputed recommended intake, the calorie intake display block 42 will warn the user by a warning color block 421 with a color darker than that of the balance pointer 41 (as shown in FIG. 4). Now, the user should think of a way to maintain the heartbeat value at the effective heartbeat range through exercise, so as to increase the calorie consumption. After the amount of exercise offsets the foregoing exceeded value, the two can obtain a balance. Of course, the user can achieve the weight loss effect by further increasing the amount of exercise.

The determination of an appropriate amount of exercise can be achieved by detecting whether the user's heartbeat has reached the so-called effective heartbeat range by the heartbeat detector 30, and the APP imputation software program can convert the effective heartbeat range into the actual caloric value according to a conversion formula, and an exercise color block 431 with a darker color is displayed before the calorie burn display block 43 (as shown in FIG. 5), so that when the user consumes more calories by additional exercises, the length of the calorie intake display block 42 can be shorted by the offset. In other words, the larger the amount of exercise, the larger food intake is allowed while maintaining the expected purpose of controlling body weight.

The body weight scale 20 and the heartbeat detector 30 can transmit related data to a portable electronic device 10 via a cable or wireless transmission technology.

In addition, the portable electronic device 10 and its APP imputation software program of the invention can be operated with the heartbeat detector 30 to perform a detection operation and detect the user's heartbeat recovery rate, wherein the detected actual values can be displayed on the operation interface 11 (not shown in the figure) directly, so that when users find that their heartbeat recovery rate is improved or keeps improving, it will encourage the users to control their body weight and diet and keep doing exercise.

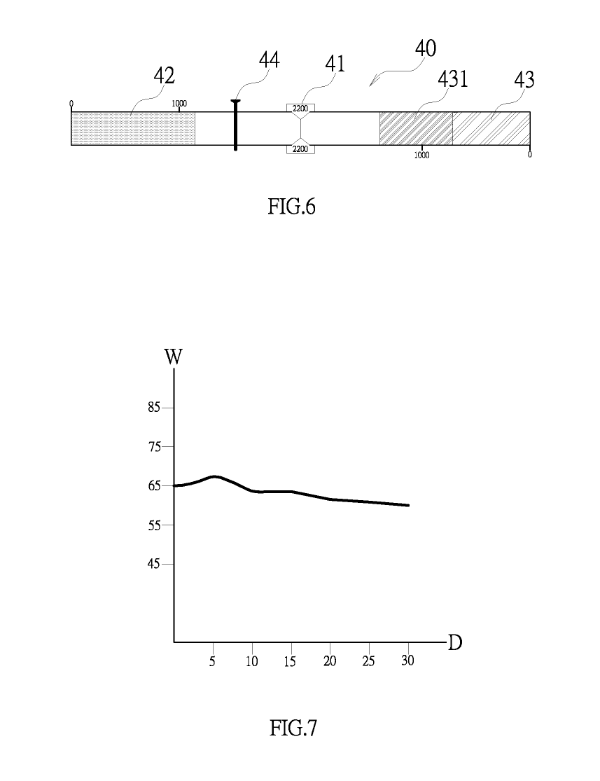

For the purposes of losing weight and managing aerobic training or match training the users can select their desired execution column on a function menu of the operation interface 11. Now, the APP imputation software program will impute a target consumption value according to all of the user's physiological conditions and previous records, and the target consumption value will be displayed by a target pointer 44 on the concise balance chart 40 (as shown in FIG. 6). Therefore, the users can learn their basal metabolic rate as well as the additional calorie consumption to think of a way of achieving the expected effects of increasing the calorie consumption by doing various different exercises.

In fact, it is impossible for us to maintain our daily calorie intake and consumption in balance all the time, so that the present invention draws an execution performance chart according to the daily recorded values as show in FIG. 7 and provides the chart for the users' reference. In FIG. 7, the y-axis represents the body weight (W), and the x-axis represents the number of days (D), so that users can review the change of their body weight to have a better understanding on how to control and manage their body type to become an ideal one.

In the conventional calorie burn conversion, the mechanical power (such as exercise distance and exercise time) is converted into a caloric value directly, but this conventional conversion has not taken whether the user's heartbeat has reached the “effective heartbeat range’ into consideration, so that the accuracy and value of reference may be reduced significantly. In the meantime, users usually doubt the effect of their exercise. On the other hand, the present invention has a good control on the users' actual amount of exercise by the “effective heartbeat range” to enhance the practical benefit and management effect significantly.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A physiology and exercise management system based on body weight difference and heartbeat rate, comprising a portable electronic device with a built-in APP imputation software program, a body weight scale and a heartbeat detector, wherein the APP imputation software program has an imputation basis based on a basic parameter conversion table including an international standard body mass index value, a basal metabolic rate and a standard exercise heartbeat rate, so that when a user executes the APP imputation software program by a portable electronic device, the user inputs the user's personal basal physiological parameter through an operation interface first and obtains the most updated actual body weight value through an automatic transmission from the body weight scale, and then the user can obtain a body weight difference value between the user's current body weight and an international standard body mass index, and further imputes the user's basal metabolic rate and ideal calorie intake to be displayed on an operation interface of the portable electronic device through a concise balance chart, and then the heartbeat detector timely and automatically transmits the user's current heartbeat rate and performs a conversion process and detects an oxygen exercise uptake, so as to learn the user's calorie consumption situation and display the situation in the concise balance chart synchronously, while the APP imputation software program records and updates the specific user's previous use result.

2. The physiology and exercise management system based on body weight difference and heartbeat rate as recited in claim 1, wherein when the portable electronic device executes the APP imputation software program, a function menu column is displayed on the operation interface, and the function menu column comprises a health management, a weight loss management, an aerobic training management and a match training management.

3. The physiology and exercise management system based on body weight difference and heartbeat rate as recited in claim 1, further comprising a balance pointer disposed at the middle of the concise balance chart for displaying the imputed calorie value, and the balance pointer serves as a boundary for dividing one side as an actual calorie intake display block and the other side as a calorie burn display block.

4. The physiology and exercise management system based on body weight difference and heartbeat rate as recited in claim 1, wherein the body weight scale and the heartbeat detector transmit related data to the portable electronic device through a cable or wireless transmission technology.

5. The physiology and exercise management system based on body weight difference and heartbeat rate as recited in claim 1, wherein when the portable electronic device and the APP imputation software program in line with a heartbeat detector to perform a detection operation, the user's heartbeat recovery rate is detected at the same time, and the detected actual value is displayed directly on the operation interface.

6. The physiology and exercise management system based on body weight difference and heartbeat rate as recited in claim 1, wherein the APP imputation software program imputes a target consumption value according to all of the user's physiological conditions and previous records for the purpose of a weight loss, an aerobic training or a match training, and the target consumption value is displayed by a target pointer on the concise balance chart.

7. The physiology and exercise management system based on body weight difference and heartbeat rate as recited in claim 1, wherein the physiology and exercise management system automatically draws an execution performance chart according to a daily recorded value.
